(19) United States
(12) Patent Application Publication
(10) Pub. No.: US 2013/0289891 A1
(43) Pub. Date: Oct. 31, 2013

(54) Rank Normalization for Differential Expression Analysis of Transcriptome Sequencing Data

(71) Applicants: Niina S. Haiminen, White Plains, NY (US); Laxmi P. Parida, Mohegan Lake, NY (US)

(72) Inventors: Niina S. Haiminen, White Plains, NY (US); Laxmi P. Parida, Mohegan Lake, NY (US)

(73) Assignee: INTERNATIONAL BUSINESS MACHINES CORPORATION, Armonk, NY (US)

(21) Appl. No.: 13/547,933

(22) Filed: Jul. 12, 2012

Related U.S. Application Data
(63) Continuation of application No. 13/459,529, filed on Apr. 30, 2012.

(51) Int. Cl. G06F 19/00

(52) U.S. Cl. 702/20

(57) ABSTRACT

A computer system for rank normalization for differential expression analysis of transcriptome sequencing data includes a processor; and a memory comprising a first dataset comprising transcriptome sequencing data, the first dataset comprising a plurality of genes and a respective ranking value associated with each of the plurality of genes, the system configured to perform a method including assigning a rank to each of the genes of the plurality of genes based on the ranking value to produce a first rank normalized dataset; determining a change between a first rank of a particular gene in the first rank normalized dataset, and a second rank of the particular gene in a second rank normalized dataset, the second rank normalized dataset being based on a second dataset comprising transcriptome sequencing data; and determining whether the particular gene is differentially expressed between the first and second datasets based on the determined change in rank.

### CROSS-REFERENCE TO RELATED APPLICATION

This application is a continuation of U.S. application Ser. No. 13/459,529 filed on Apr. 30, 2012.

### BACKGROUND

This disclosure relates generally to the field of messenger riboneucleic acid sequencing, and more particularly to differential expression (DE) analysis of transcriptome sequencing data based on rank normalization.

Transcriptome data, including messenger riboneucleic acid (mRNA) data, may arise from genes, and more specifically from gene transcripts. A gene may have multiple differently spliced transcripts that give rise to mRNAs, and mRNAs may also arise from other regions on the genome. Sequencing technologies may provide data for a wide range of biological applications, and are powerful tools for investigating and understanding mRNA expression profiles. There is no limit on the number of mRNAs that may be surveyed by sequencing. Sequencing may not be target specific, so the genes that are examined do not have to be pre-selected, providing a wide dynamic range of data and also allowing the possibility of discovering new sequence variants and transcripts. Various sequencing platforms may be used to perform mRNA sequencing and to produce mRNA sequencing datasets, each dataset corresponding to an assay of a particular sample. Such mRNA sequencing technologies may be high-throughput and produce relatively large amounts of gene data. The size of a gene sequencing dataset may require the use of various computational techniques to make accurate and meaningful inferences regarding sequenced mRNAs from the dataset. In addition, datasets from different assays (which may be from the same sample at different points in time, or from different samples) may also need to be compared. Analyzing data regarding relatively large numbers of mRNAs based on their activity, or expression, levels across different assays may be a relatively complex process.

Determination of differential expression, which is a change in an expression level of the gene from first dataset corresponding to a first assay to a second dataset corresponding to a second assay, for a gene, a gene transcript, or a mRNA may give important information regarding the gene, gene transcript, or mRNA. The detection of differential expression in participating genes across different assays may be affected by the characteristics of the sequencing platform, and also by computational techniques that are used to analyze the data. In particular, differential expression evaluations may be biased by scaling of expression estimates. Scaling, which may be uniform or non-uniform, may be performed on gene sequencing datasets in order to normalize expression values for comparison of gene data across different assays. A transcriptome sequencing dataset may be scaled by total lane counts, using a technique referred to as reads per kilobase per million mapped reads (RPKM). While platform-specific inaccuracies may be addressed using error models, scaling error may be innate to many transcriptome data analysis approaches.

### BRIEF SUMMARY

In one aspect, a computer program product comprising a computer readable storage medium containing computer code that, when executed by a computer, implements a method for rank normalization for differential expression analysis of transcriptome sequencing data, wherein the method includes receiving, by a computer, a first dataset comprising transcriptome sequencing data, the first dataset comprising a plurality of genes, and further comprising a respective ranking value associated with each of the plurality of genes; assigning a rank to each of the genes of the plurality of genes based on the ranking value to produce a first rank normalized dataset; determining a change between a first rank of a particular gene in the first rank normalized dataset, and a second rank of the particular gene in a second rank normalized dataset, the second rank normalized dataset being based on a second dataset comprising transcriptome sequencing data; and determining whether the particular gene is differentially expressed between the first dataset and the second dataset based on the determined change in rank.

In another aspect, a computer system for rank normalization for differential expression analysis of transcriptome sequencing data includes a processor; and a memory, the memory comprising a first dataset comprising transcriptome sequencing data, the first dataset comprising a plurality of genes, and further comprising a respective ranking value associated with each of the plurality of genes, the system configured to perform a method including assigning, by the processor, a rank to each of the genes of the plurality of genes based on the ranking value to produce a first rank normalized dataset; determining a change between a first rank of a particular gene in the first rank normalized dataset, and a second rank of the particular gene in a second rank normalized dataset, the second rank normalized dataset being based on a second dataset comprising transcriptome sequencing data; and determining whether the particular gene is differentially expressed between the first dataset and the second dataset based on the determined change in rank.

Additional features are realized through the techniques of the present exemplary embodiment. Other embodiments are described in detail herein and are considered a part of what is claimed. For a better understanding of the features of the exemplary embodiment, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 illustrates a graph of gene length versus expression level for example genes in a sample.

FIG. 2 illustrates a flowchart of an embodiment of a method for rank normalization for differential expression analysis of transcriptome sequencing data.

FIG. 3 illustrates a flowchart of an embodiment of a method for bin-based rank normalization.

FIG. 4 illustrates a flowchart of an embodiment of a method for statistical significance computation of rank differentials.

FIG. 5 illustrates an embodiment of a computer that may be used in conjunction with systems and methods for differential expression analysis of transcriptome sequencing data.

### DETAILED DESCRIPTION

Embodiments of systems and methods for rank normalization for differential expression analysis of transcriptome sequencing data are provided, with exemplary embodiments being discussed below in detail. Normalization of transcriptome sequencing data may be based on the relative placement of the genes in the dataset with respect to the other genes in the dataset. The term gene, as used herein, may also refer to any transcriptome sequencing data, including a transcript or mRNA in various embodiments. Rank normalization of gene data yields unit-free numbers for each gene that may be used to make comparisons across data sets. Rankings may be determined for individual genes within a dataset, and then rank differentials for particular genes may be determined between datasets. The two datasets that are compared may comprise transcriptome sequencing data from two different samples in some embodiments, or may comprise transcriptome sequencing data from a single sample at two different points in time in other embodiments. This allows determination of differential expression of various genes without use of scaling. Rank normalization may be used in conjunction with transcriptome sequencing data obtained using any appropriate sequencing platform. Differential expression, including overexpression and underexpression, of genes may be detected based on the rank-differentials. An increase in the assigned rank of a gene between first and second samples may be interpreted as overexpression, and a decrease in rank may be interpreted as underexpression. The determined differential expression information may be used for various biological applications, such as functional genomics and comparative transcriptomics.

The genes are ranked based on a ranking value, which is a value for which data is available in the dataset for each ranked gene. The genes may be ordered in ascending or descending order of the ranking value to produce a rank normalized dataset in various embodiments. In some embodiments, each gene in the dataset may be assigned a unique ranking. In other embodiments, the rankings may be determined based on assigning genes to bins, each bin comprising a range of values. Each gene assigned to the same bin is therefore assigned the same rank, and changes in bin number for a particular gene between datasets may be used to determine the differential expression of the particular gene. The range of values corresponding to each bin may be determined based on linear regression analysis of the dataset that is being rank normalized, so that the bin ranges may be tailored to the particular dataset.

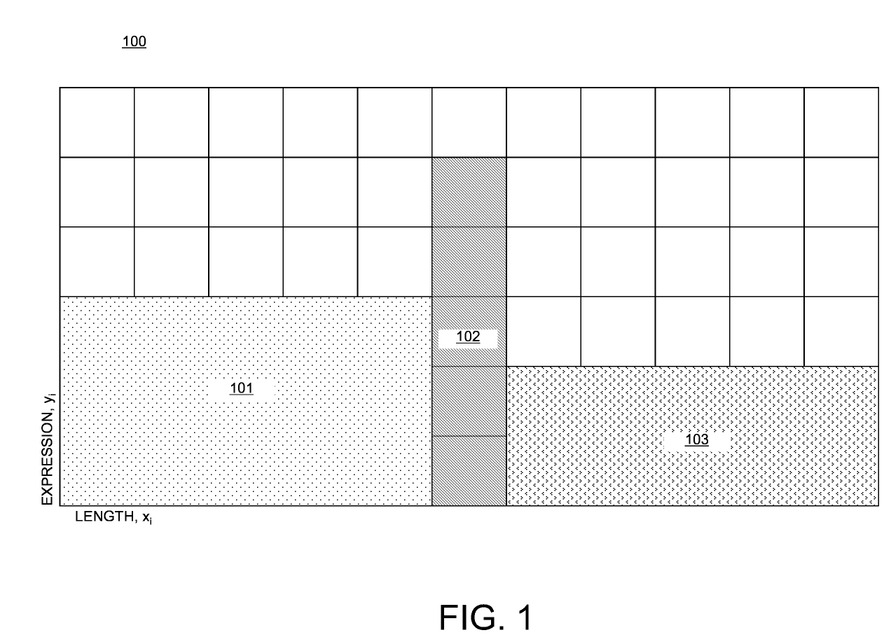

A transcriptome sequencing dataset comprises various type of gene data, including read counts (cᵢ) that are determined for each gene gᵢ, and also the number of bases per gene, which is referred to as gene length (xᵢ, which is expressed in kilobases, or kb). The expression level (yᵢ) of a gene gᵢ is equal to cᵢ/xᵢ. FIG. 1 shows a graph 100 of gene length versus expression level for example genes in a sample. Graph 100 shows rectangles corresponding to three genes 101, 102, and 103, with differing gene lengths and expression levels. The read counts of the three genes 101-103 are proportional to the areas of the respective rectangles. The respective read counts, gene lengths, and expression levels for each of genes 101-103 are given in Table 1 below. Table 1 further illustrates RPKM normalization of the data regarding genes 101-103, which is a scaled normalization.

TABLE 1
Gene Data and Normalization

| | Unit | Gene 101 | Gene 102 | Gene 103 |
|---|---|---|---|---|
| Per gene: | count | 150 | 50 | 100 |
| read count (cᵢ) | | | | |
| Gene length (xᵢ) | kb | 5 | 1 | 5 |
| Expression | count/kb | 30 | 50 | 20 |
| (yᵢ = cᵢ/xᵢ) | | | | |
| M = Σᵢcᵢ | count | 300 = 0.0003 × 10⁶ | | |
| Normalized gene | 1/kb | 1/10 | 1/6 | 1/15 |
| expression | | | | |
| (zᵢ = yᵢ/M) | | | | |
| Gene RPKMᵢ | 1/kb | (1/10) × 10⁶ | (1/6) × 10⁶ | (1/15) × 10⁶ |
| (zᵢ × 10⁶) | | | | |

The number of genes g, in the dataset is N, cᵢ is the read count of a gene gᵢ, and xᵢ is the length in kb of gene i, for i from 1 to N. For RPKM normalization, a value zᵢ is attributed to each gene g, assuming M is equal to 1. Σᵢxᵢzᵢ is therefore equal to 1 because zᵢ is normalized. RPKM, is a value attributed to each gene gᵢ assuming M is equal to 10⁶. The values cᵢ and yᵢ for each gene gᵢ are related to RPKM, by the following relationships:

cᵢ=RPKMᵢxᵢM; and EQ. 1

yᵢ=RPKMᵢM EQ. 2.

Count cᵢ is an unscaled value, while zᵢ and RPKMᵢ are scaled. RPKM normalization gives a scaled value (i.e., zᵢ×10⁶) having unit of 1/kb for each gene gᵢ; the scaling may introduce distortions into differential expression analysis that is performed using the RPKM values.

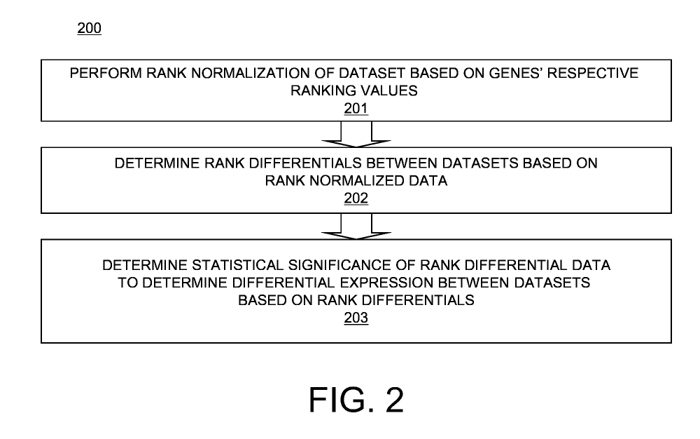

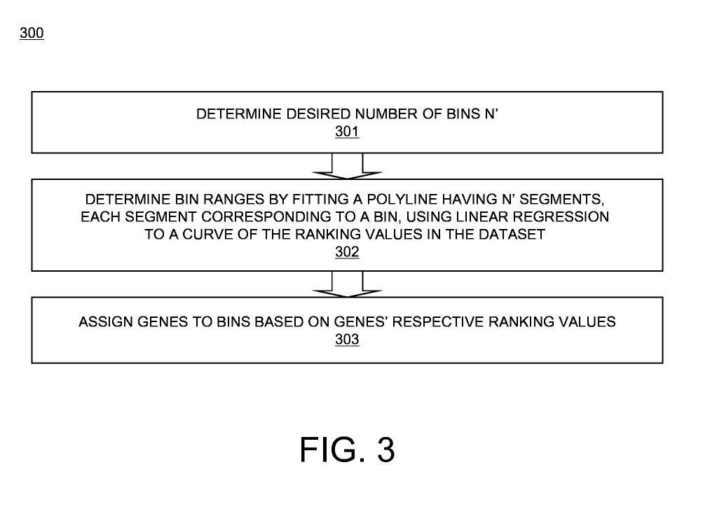

Rank normalization of the gene data, which gives an unscaled, unit-free value for each gene that may be used to perform differential expression analysis, may be performed based on cᵢ and/or yᵢ values for each gene gᵢ in various embodiments. FIG. 2 illustrates an embodiment of a method 200 for rank normalization for differential expression analysis of transcriptome sequencing data. First, in block 201, rank normalization of a dataset comprising transcriptome sequencing data is performed. In order to perform the rank normalization, the genes within a single dataset are ordered based on a ranking value, and each gene is assigned a ranking relative to the other genes in the same data set. In various embodiments, the ranking value may be the read count (cᵢ) or expression level (yᵢ) values for the genes, which are unscaled values. In further embodiments, the ranking value may be the value of log (cᵢ) or log (yᵢ), as log (cᵢ) and log (yᵢ) maintain the same order of the genes as ordering by cᵢ or yᵢ. In various embodiments, the genes may be ranked from lowest to highest, or from highest to lowest. In block 201 of FIG. 2, each gene gᵢ is assigned a rank rᵢ. In some embodiments, rᵢ is a unique value from 1 to N, where N is the number of genes gᵢ in the sample. In other embodiments, rank normalization may be performed based on binning, which is discussed in further detail below with respect to FIG. 3.

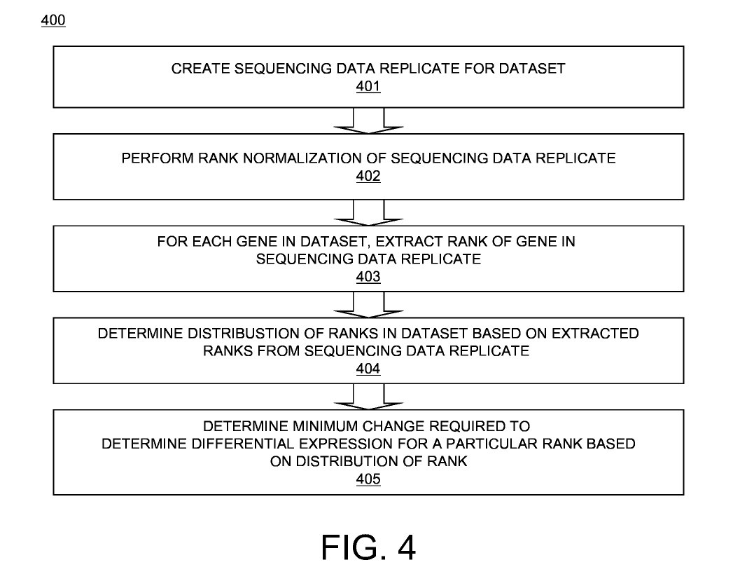

Next, flow of method 200 proceeds to block 202, in which rank differentials for specific genes between two rank normalized datasets are determined. The two datasets may comprise data from assays of a single sample at different points in time, or may comprise data from assays of different samples. The two rank normalized datasets that are compared in block 202 may each comprise the same number of genes N, with gene rankings going from 1 to N, or, in embodiments in which rank normalization is performed based on binning (see FIG. 3 below), the same number of bins N′, with gene rankings going from 1 to N′. Rank differentials are determined based on the difference between the assigned ranking of a gene in the first dataset and the assigned ranking of the gene in the second dataset. An increase in rank rᵢ of a gene gᵢ from a first sample to a second sample may be interpreted as overexpression of gene gᵢ, and a decrease in rank rᵢ may be interpreted as underexpression of gene gᵢ. A stable gene gᵢ may not have a significant change in its rᵢ between the datasets. Lastly, in block 203, statistical significance computation of the rank differentials is performed to assign a significance value to the determined rank differentials. A minimum amount of change in a gene's rank may be required for the gene to be considered differentially expressed; the necessary amount of the minimum change may be determined based on the significance computation. Statistical significance computation of rank differentials is discussed in further detail with respect to FIG. 4. The rank differentials and statistical significance determinations of blocks 202 and 203 of FIG. 2 comprise differential expression analysis of the genes.

The example of FIG. 1 and Table 1 is continued in Table 2, which shows ranking values for the genes 101-103 of FIG. 1 that were determined using method 200 of FIG. 2. The various embodiments of ranking schemes using different ranking values may order the three genes differently, as shown; therefore, the same ranking scheme is applied across datasets that are compared to one another for determination of differential expression.

TABLE 2
Example Gene Rankings

| Ranking Value | unit | gene 101 | gene 102 | gene 103 |
|---|---|---|---|---|
| cᵢ | rᵢ | 3 | 1 | 2 |
| yᵢ | rᵢ | 2 | 3 | 1 |
| Log (cᵢ) | rᵢ | 3 | 1 | 2 |
| Log (yᵢ) | rᵢ | 2 | 3 | 1 |

FIG. 3 illustrates an embodiment of a method 300 for bin-based rank normalization of a transcriptome sequencing dataset, which may be performed in some embodiments of block 201 of FIG. 2. Genes with similar ranking values may be deemed rank-indistinguishable. Therefore, instead of assigning a unique rank to each gene gᵢ as was discussed above, the genes may be assigned to bins, or ranges, such that all genes assigned to a single bin are assigned the same rank rᵢ. First, in block 301, a desired number of bins N′ is determined. N′ may be determined based on the number of genes N in the dataset. Then, in block 302, linear regression is used to fit a polyline with N′ linear segments to a cumulative curve of a graph of the ranking values (i.e., yᵢ, log (cᵢ), or log (yᵢ)) in the dataset. Each linear segment of the polyline corresponds to a bin having a range of values of the ranking value. In some embodiments, the value of N may be in tens or hundreds of thousands whereas N′ may be a much smaller number, for example, of the order or tens to hundreds (i.e., N′<<N). Lastly, the genes are each assigned to the appropriate bin based on ranking value in block 303, and the rank rᵢ each gene gᵢ is determined based on the bin number of the assigned bin of each gene gᵢ. For example, all genes in a bin bₖ, where k goes from 1 to N′, are assigned the same rank rᵢ that is equal to k.

FIG. 4 illustrates an embodiment of a method 400 for statistical significance computation of rank differentials, which may be performed in block 203 of method 200 of FIG. 2. Given a dataset S corresponding to transcriptome sequencing data from an assay of a sample, the rank distributions in S may be used to determine the statistical significance of a given change in rank, so as to determine if a change in rank for a particular gene is sufficient to determine that the gene is differentially expressed (i.e., overexpressed or underexpressed). For example, a gene that is ranked in the middle of the dataset may require a greater amount of change in rank to be considered differentially expressed than a gene that is ranked high or low in the dataset. This statistical significance calculation may be determined based on a P-value threshold, which may give a threshold for determining the necessary minimum change, and may be set by a user. First, in block 401 of method 400, transcriptome sequencing data replicate S′ⱼ is created. The replicate is created such that that the cumulative read count curve of S′ⱼ matches that of the given sample S by sampling on the cumulative curve of S. Next, in block 402, rank normalization of the data in S′ⱼ is performed as was discussed above with respect to block 201 of FIG. 2. For embodiments in which gene ranks in S were assigned based on binning as was described by method 300 of FIG. 3, the same binning scheme that was used for S is used in the replicate S′ⱼ, in block 402 of FIG. 4. Then, in block 403 of method 400, for each gene in S with a rank r, the rank r′ⱼ for the gene in S′ⱼ is extracted. Lastly, in block 404 of method 400, the distribution of the respective ranks r of corresponding to the genes in S are obtained based on the corresponding values r′ⱼ in S′ⱼ. Lastly, the distribution of rankings is used to determine the statistical significance of differences between rankings, and thereby determine the minimum change in a gene's rank from one dataset to another that is needed for the gene to be considered differentially expressed for a gene having a particular rank in block 405 of method 400. Method 400 may be repeated m times (i.e., j goes from 1 to m) to extract rank distributions in dataset S.

Differential expression data determined using rank normalization as described above with respect to FIGS. 2-4 may be used for functional inferences of individual genes and their networks using, for example, comparative transcriptomics. For example, let S₁, S₂, . . . , S_{M} be rank normalized transcriptomic data in M different samples and/or time points. Let the number of genes in each set S be N. Various matrices of the transcriptomic data may be used to categorize genes, samples, and or time periods across sets. In a first embodiment, a M×N two-dimensional permutation matrix P_{π}, of gene rankings may be defined by:

P_{π}[i,j]=n, EQ. 3

where n is the rank of gene j in Sᵢ. The M samples may be hierarchically clustered based on distance measurements between any pair of rows in matrix P_{π}. To determine a distance measurement between two rows in matrix P_{π}, if rankᵢ(k) denotes the rank of gene k in Sᵢ, the distance d between a pair Sᵢ and Sⱼ (i.e., d(Sᵢ, Sⱼ)) may be defined as:

d(Sᵢ,Sⱼ)={square root over (Σₖ₌₁^{N}(rankᵢ(k)−rankⱼ(k))²)} EQ. 4.

According to these definitions, d(Sᵢ, Sⱼ)=0 and d(Sᵢ, Sⱼ)=d(Sⱼ, Sᵢ). Clustering, as determined by the distance measurements defined by EQ. 4, in the matrix P_{π} may be used to determine various gene characteristics across samples.

In a second embodiment, a M×M×N three-dimensional comparative matrix C_{δ}[i, j, k], wherein i and j are sample numbers being compared, and k is a gene number, may be defined as follows:

$${C}_{δ} [ i , j , k ] = \{ \begin{matrix}X , if i = j ; \\ 1 , if i \neq j and gene k is overexpressed between {S}_{i} and {S}_{j} ; \\ - 1 , if i \neq j and gene k is underexpressed between {S}_{i} and {S}_{j} ; \\ 0 , otherwise\end{matrix} \qquad EQ . 5$$

The value of X is to be interpreted as undefined. Based on matrix C_{δ}, clustering of the genes on the x, y, and/or z-axes, or clustering of sample-pairs on the x and y axis, may be determined. This allows determination of similarities and differences between genes across different samples.

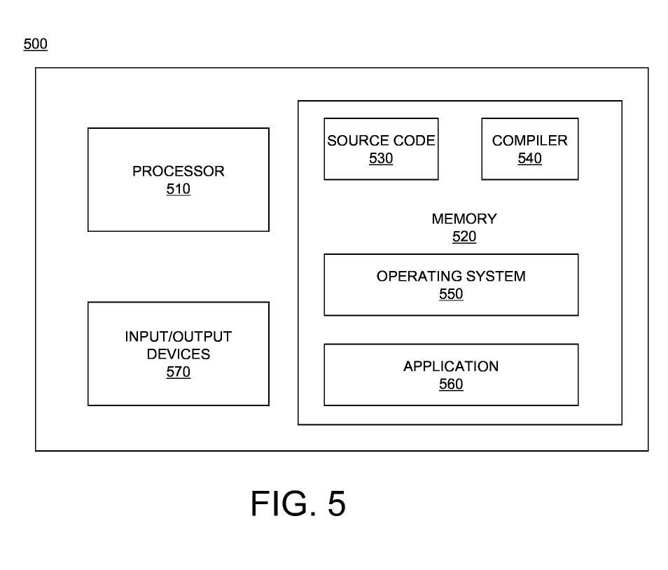

FIG. 5 illustrates an example of a computer 500 which may be utilized by exemplary embodiments of a method for rank normalization for differential expression analysis of transcriptome sequencing data as embodied in software. Various operations discussed above may utilize the capabilities of the computer 500. One or more of the capabilities of the computer 500 may be incorporated in any element, module, application, and/or component discussed herein.

The computer 500 includes, but is not limited to, PCs, workstations, laptops, PDAs, palm devices, servers, storages, and the like. Generally, in terms of hardware architecture, the computer 500 may include one or more processors 510, memory 520, and one or more input and/or output (I/O) devices 570 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 510 is a hardware device for executing software that can be stored in the memory 520. The processor 510 can be virtually any custom made or commercially available processor, a central processing unit (CPU), a digital signal processor (DSP), or an auxiliary processor among several processors associated with the computer 500, and the processor 510 may be a semiconductor based microprocessor (in the form of a microchip) or a macroprocessor.

The memory 520 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 520 may incorporate electronic, magnetic, optical, and/or other types of storage media. Note that the memory 520 can have a distributed architecture, where various components are situated remote from one another, but can be accessed by the processor 510.

The software in the memory 520 may include one or more separate programs, each of which comprises an ordered listing of executable instructions for implementing logical functions. The software in the memory 520 includes a suitable operating system (O/S) 550, compiler 540, source code 530, and one or more applications 560 in accordance with exemplary embodiments. As illustrated, the application 560 comprises numerous functional components for implementing the features and operations of the exemplary embodiments. The application 560 of the computer 500 may represent various applications, computational units, logic, functional units, processes, operations, virtual entities, and/or modules in accordance with exemplary embodiments, but the application 560 is not meant to be a limitation.

The operating system 550 controls the execution of other computer programs, and provides scheduling, input-output control, file and data management, memory management, and communication control and related services. It is contemplated by the inventors that the application 560 for implementing exemplary embodiments may be applicable on all commercially available operating systems.

Application 560 may be a source program, executable program (object code), script, or any other entity comprising a set of instructions to be performed. When a source program, then the program is usually translated via a compiler (such as the compiler 540), assembler, interpreter, or the like, which may or may not be included within the memory 520, so as to operate properly in connection with the O/S 550. Furthermore, the application 560 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 570 may include input devices such as, for example but not limited to, a mouse, keyboard, scanner, microphone, camera, etc. Furthermore, the I/O devices 570 may also include output devices, for example but not limited to a printer, display, etc. Finally, the I/O devices 570 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 570 also include components for communicating over various networks, such as the Internet or intranet.

If the computer 500 is a PC, workstation, intelligent device or the like, the software in the memory 520 may further include a basic input output system (BIOS) (omitted for simplicity). The BIOS is a set of essential software routines that initialize and test hardware at startup, start the O/S 550, and support the transfer of data among the hardware devices. The BIOS is stored in some type of read-only-memory, such as ROM, PROM, EPROM, EEPROM or the like, so that the BIOS can be executed when the computer 500 is activated.

When the computer 500 is in operation, the processor 510 is configured to execute software stored within the memory 520, to communicate data to and from the memory 520, and to generally control operations of the computer 500 pursuant to the software. The application 560 and the O/S 550 are read, in whole or in part, by the processor 510, perhaps buffered within the processor 510, and then executed.

When the application 560 is implemented in software it should be noted that the application 560 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 560 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 560 is implemented in hardware, the application 560 can be implemented with any one or a combination of the following technologies, which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The technical effects and benefits of exemplary embodiments include determination of differential expression of genes, or transcripts or mRNAs, between datasets of mRNA sequencing data without error induced by scaling.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer system for rank normalization for differential expression analysis of transcriptome sequencing data, the system comprising:
a processor; and
a memory, the memory comprising a first dataset comprising transcriptome sequencing data, the first dataset comprising a plurality of genes, and further comprising a respective ranking value associated with each of the plurality of genes, the system configured to perform a method comprising:
assigning a rank to each of the genes of the plurality of genes based on the ranking value to produce a first rank normalized dataset, the ranking value is based on a read count respectively for each of the genes;
determining a change between a first rank of a particular gene in the first rank normalized dataset, and a second rank of the particular gene in a second rank normalized dataset, the second rank normalized dataset being based on a second dataset comprising transcriptome sequencing data;
determining whether the particular gene is differentially expressed between the first dataset and the second dataset based on the determined change in rank;
wherein determining whether the particular gene is differentially expressed between the first dataset and the second dataset based on the determined change in rank comprises: determining whether the determined change in rank is greater than a minimum change threshold, the minimum change threshold corresponding to the rank of the particular gene in the first dataset;
in an event the particular gene is ranked in a middle of the first dataset, requiring a greater amount of determined change in the rank for the particular gene to be considered differentially expressed as compared to another gene that is not ranked in the middle.

2. The system of claim 1, wherein the ranking value comprises a gene count of a respective gene.

3. The system of claim 2, wherein the ranking value comprises a logarithm of the gene count of the respective gene.

4. The system of claim 1, wherein the ranking value comprises an expression level of the respective gene.

5. The system of claim 4, wherein the ranking value comprises a logarithm of the expression level of the respective gene.

6. The system of claim 1, wherein the first dataset comprises a number N of genes, and wherein each gene in the first dataset is assigned a unique rank between 1 and N based on the gene's respective ranking value.

7. The system of claim 1, wherein assigning the rank to each of the genes of the plurality of genes based on the ranking value to produce the first rank normalized dataset comprises:
determining a plurality of bins, each bin comprising a range of values of the ranking value;
assigning each gene to a bin of the plurality of bins based on the gene's respective ranking value, wherein genes that are assigned to the same bin are assigned the same rank.

8. The system of claim 7, wherein the plurality of bins is determined based on fitting a polyline, the polyline comprising a plurality of segments, by linear regression to a graph of the ranking values of the first dataset, wherein each of the plurality of segments corresponds to a bin of the plurality of bins.

9. The system of claim 1, wherein determining whether the particular gene is differentially expressed between the first dataset and the second dataset based on the determined change in rank comprises:
in the event the determined change in rank is determined to be greater than the minimum change threshold, determining that the particular gene is differentially expressed.

10. The system of claim 9, wherein the minimum change threshold is determined based on a statistical significance of the determined change in rank.

11. The system of claim 10, wherein the statistical significance of the determined change in rank is determined based on a rank normalized replicate of the first dataset.

12. The system of claim 1, wherein the particular gene is determined to be overexpressed between the first dataset and the second dataset in the event the determined change in rank comprises an increase in rank from the first dataset to the second dataset.

13. The system of claim 1, wherein the particular gene is determined to be underexpressed between the first dataset and the second dataset in the event the determined change in rank comprises a decrease in rank from the first dataset to the second dataset.

14. A computer program product comprising a non-transitory computer readable storage medium containing computer code that, when executed by a computer, implements a method for rank normalization for differential expression analysis of transcriptome sequencing data, wherein the method comprises:
receiving, by a computer, a first dataset comprising transcriptome sequencing data, the first dataset comprising a plurality of genes, and further comprising a respective ranking value associated with each of the plurality of genes;
assigning a rank to each of the genes of the plurality of genes based on the ranking value to produce a first rank normalized dataset;
determining a change between a first rank of a particular gene in the first rank normalized dataset, and a second rank of the particular gene in a second rank normalized dataset, the second rank normalized dataset being based on a second dataset comprising transcriptome sequencing data;
determining whether the particular gene is differentially expressed between the first dataset and the second dataset based on the determined change in rank;
wherein determining whether the particular gene is differentially expressed between the first dataset and the second dataset based on the determined change in rank comprises: determining whether the determined change in rank is greater than a minimum change threshold, the minimum change threshold corresponding to the rank of the particular gene in the first dataset;
in an event the particular gene is ranked in a middle of the first dataset, requiring a greater amount of determined change in the rank for the particular gene to be considered differentially expressed as compared to another gene that is not ranked in the middle.

15. The computer program product according to claim 14, wherein the ranking value comprises one of a gene count of a respective gene, a logarithm of the gene count of the respective gene, an expression level of the respective gene, and a logarithm of the expression level of the respective gene.

16. The computer program product according to claim 14, wherein the first dataset comprises a number N of genes, and wherein each gene in the first dataset is assigned a unique rank between 1 and N based on the gene's respective ranking value.

17. The computer program product according to claim 14, wherein assigning the rank to each of the genes of the plurality of genes based on the ranking value to produce the first rank normalized dataset comprises:
determining a plurality of bins, each bin comprising a range of values of the ranking value;
assigning each gene to a bin of the plurality of bins based on the gene's respective ranking value, wherein genes that are assigned to the same bin are assigned the same rank.

18. The computer program product according to claim 17, wherein the plurality of bins is determined based on fitting a polyline, the polyline comprising a plurality of segments, by linear regression to a graph of the ranking values of the first dataset, wherein each of the plurality of segments corresponds to a bin of the plurality of bins.

19. The computer program product according to claim 14, wherein determining whether the particular gene is differentially expressed between the first dataset and the second dataset based on the determined change in rank comprises:
in the event the determined change in rank is determined to be greater than the minimum change threshold, determining that the particular gene is differentially expressed.

20. The computer program product according to claim 19, wherein the minimum change threshold is determined based on a statistical significance of the determined change in rank.
